(19) United States
(12) Patent Application Publication
(10) Pub. No.: US 2021/0155515 A1
(43) Pub. Date: May 27, 2021

(54) ORGANIC INDUSTRIAL TAILWATER TREATMENT METHOD BASED ON SIMULTANEOUS COMBINATION OF OZONATION AND BIODEGRADATION (SCOB)

(71) Applicant: Northeast Normal University, Changchun City (CN)

(72) Inventors: Dandan ZHOU, Changchun City (CN); Yuanyu SU, Changchun City (CN); Shuangshi DONG, Changchun City (CN); Liang FU, Changchun City (CN); Chen ZHOU, Changchun City (CN); Bruce RITTMANN, Changchun City (CN)

(21) Appl. No.: 17/100,619

(22) Filed: Nov. 20, 2020

(30) Foreign Application Priority Data
Nov. 22, 2019 (CN) 201911154676.5

(51) Int. Cl. C02F 1/78; C02F 1/28; C02F 3/06; C02F 3/34; C02F 3/12; B01J 20/26

(52) U.S. Cl. CPC C02F 1/78; C02F 1/285; C02F 3/06; C02F 2001/007; C02F 3/121; B01J 20/262; C02F 2201/782; C02F 3/34

(57) ABSTRACT

An organic industrial tailwater treatment method based on simultaneous combination of ozonation and biodegradation (SCOB), includes: placing a sponge carrier that is internally attached and grown with a biofilm in a recycle reactor; introducing air into an ozone generator to generate ozone; and introducing the ozone into the recycle reactor; where the ozone output of the recycle reactor is adjusted through a flow meter and an ozone generator adjustment knob, the sponge carrier is uniformly fluidized under the action of the ozone, and microorganisms loaded on the sponge carrier cooperate with the ozone to degrade pollutants. Easily degradable organic substances produced from the ozonation of the present disclosure can be quickly utilized by the microorganisms in the internal pores of the composite carrier, which improves the degradation and mineralization efficiency of pollutants.

### CROSS-REFERENCE TO PRIOR APPLICATIONS

The present application is based on and claims priority to China Patent Application No. 201911154676.5, filed Nov. 22, 2019, the contents of which are incorporated herein by reference.

### U.S. GOVERNMENT SUPPORT

Not applicable

### BACKGROUND OF THE INVENTION

### Area of the Art

The present disclosure belongs to the technical field of wastewater treatment, and particularly relates to an organic industrial tailwater treatment method based on simultaneous combination of ozonation and biodegradation (SCOB).

### Description of the Background

Industrial wastewater refers to the waste liquor and wastewater generated during an industrial production process, including industrial production materials that are washed away by water, by-products, intermediate products and pollutants generated during production. The waste liquor mainly including organic pollutants is referred to as organic industrial tailwater, which has the characteristics of complex composition, high content of toxic substances and refractory organics, low biodegradability, and the like. Although organic industrial tailwater exhibits improved stability and quality after being treated, chemical oxygen demand (COD) of tailwater from the organic industrial tailwater treatment can still hardly meet the standard, which tends to cause environmental pollution and harm to human health. Tailwater from organic industrial tailwater treatment has a complex composition, includes many organics with low biodegradability, and is characterized by high chroma, high toxicity, poor biodegradability, and high COD, which is an important factor restricting the up-to-standard discharge of industrial wastewater.

At present, tailwater from organic industrial tailwater treatment is mainly treated by biological treatment and advanced oxidation. The biological treatment process has the problems of long hydraulic retention time (HRT) and poor degradation efficiency, and the tailwater from organic industrial tailwater treatment is difficult to further treat as it has undergone biochemical treatment.

Advanced oxidation mainly includes Fenton oxidation, potassium permanganate oxidation, photocatalytic oxidation and ozone oxidation. Although Fenton oxidation can achieve effective degradation and remove COD, chroma, etc., it requires the addition of a large quantity of chemical agents such as hydrogen peroxide and ferrous sulfate, and also results in a large amount of chemical sludge. The potassium permanganate oxidation process is simple and relatively economical, and the reduction product of manganese dioxide from the process is insoluble in water, easy to separate, and will not cause secondary pollution. However, the potassium permanganate oxidation process is selective for organic pollutants and exhibits mild oxidation when used alone. The photocatalytic oxidation process exhibits a strong oxidizing ability, achieves fast reaction, and can degrade organics with low biodegradability. However, the photocatalytic oxidation process needs to consider the preparation and recovery of catalysts and the utilization of light sources, resulting in high energy consumption and high cost. In addition, the photocatalytic oxidation is limited in reactor configuration, turbidity and chroma of tailwater, and other aspects, and thus is difficult to apply to engineering practice at present. The ozone oxidation process, which is also widely used, exhibits high oxidizability, can effectively degrade organics with low biodegradability and improve biodegradability, and produces no secondary pollution. However, the ozone oxidation alone results in poor mineralization, low ozone utilization and high operating costs. In summary, the advanced oxidation process alone is not suitable for treating organic industrial tailwater.

The principle of the ozone oxidation technology to treat industrial wastewater is as follows: ozone is a strong oxidant, with a standard electrode potential of 2.07 eV and a strong oxidizing ability second only to hydroxyl radicals, which can interact with a variety of inorganic and organic compounds, mainly acting on C═C, C≡C, C═N, —OH, —NH₂ as well as other functional groups. In an aqueous solution, ozone molecules can directly interact with pollutants in water for direct oxidation or can form reactive oxygen species (ROS) such as OH under the action of OH⁻ and achieves indirect oxidation through interaction of the OH with pollutants. Under neutral or acidic pH conditions, ozone oxidation is implemented mainly by direct reaction, which can achieve the oxidation of organics with unsaturated bonds in water. However, the direct oxidation is selective and slow, and many intermediate products will be produced during the oxidation. Under alkaline conditions, indirect oxidation is dominant, where O₃ can react with OH⁻ to produce free radicals such as .OH. The .OH free radical has a stronger oxidizing ability than O₃, exhibits no selectivity in oxidation, and can completely degrade many organic substances into carbon dioxide and water without causing secondary pollution. However, the formation of .OH is very limited during the ozone oxidation process alone, which is difficult to achieve complete mineralization, and results in low ozone utilization and large energy consumption. Therefore, ozone oxidation alone is not suitable for treating organic industrial tailwater. Although ozone oxidation alone cannot achieve complete mineralization of pollutants and is likely to cause accumulation of intermediate products, it can effectively improve the biodegradability of wastewater. Therefore, ozone oxidation and biodegradation can be combined to treat organic industrial tailwater that is difficult to biodegrade. The wastewater is treated by ozone oxidation first to improve the water quality, so that the macromolecular organic substances with low biodegradability can be converted into bioavailable substances, and the toxicity of the wastewater is reduced. In the downstream biological treatment process, microorganisms further degrade the intermediate products from ozone oxidation to achieve complete mineralization. The above method realizes the effective degradation of pollutants and improves the mineralization. However, the operation is complicated and needs to be completed in two reactors, resulting in a high operating cost.

Ozone-biological activated carbon (BAC) technology is widely used in the advanced treatment of drinking water, and it can effectively remove refractory organic substances and disinfection by-product (DBPs). This process organically combines ozone oxidation, physical adsorption, and biodegradation. First, under the strong oxidation of ozone, the organic macromolecules with low biodegradability are converted into small molecular substances, which reduces the organic load. Second, the adsorption of activated carbon (AC) is utilized to remove small molecules. Third, degradation is achieved under the action of surface microorganisms. In this system, ozone is reduced to oxygen, which can increase the dissolved oxygen (DO) in water, and the refractory organics are oxidized into easily degradable small molecules, which can provide a nutrient source to ensure the normal growth and reproduction of microorganisms, thereby realizing the degradation and mineralization of organics and improving the quality and taste of effluent water. Moreover, the organic substances adsorbed by AC is degraded under the action of microorganisms, thereby prolonging the working cycle of AC and reducing the production cost.

The advanced treatment of micro-polluted wastewater such as drinking water sources adopts ozone oxidation first and BAC, which has received wide attention and is widely applied, and the treated wastewater has low COD value (<100 mg/L). Micro-polluted water sources mainly include some dissolved organic matters (DOMs), algae, chroma, and DBPs, but organic industrial tailwater has a complicated composition, includes a large number of refractory organics and toxic inorganic ions, and still exhibits high COD. Therefore, the treatment of organic industrial tailwater requires the addition of ozone at a higher amount, which will cause biofilm oxidation during the ozone-BAC process, thereby causing the biofilm to fall off and decay and the intracellular substances to be dissolved out, thereby resulting in unstable operation of the system and secondary pollution. Therefore, the ozone-BAC process is not suitable for treating organic industrial tailwater. The organic industrial tailwater has high COD and a complicated composition, includes a large number of refractory organic substances and toxic inorganic ions, and exhibits a toxic inhibitory effect on microorganisms, and therefore, the ozone-BAC technology is not suitable for treating this type of wastewater.

Intimately coupled photocatalysis and biodegradation (ICPB) is an emerging technology that has attracted more and more attention from scholars, and the system includes a light source, a porous sponge carrier loaded with a catalyst and a biofilm, air, and an internal recycle reactor. A photocatalyst and biofilm are loaded on a porous carrier to form a composite carrier with the photocatalyst outside and the biofilm attached in the internal pores, and the destruction of biofilm in the internal pores of the carrier by light and free radicals to the biofilm is prevented due to the porous structure of the carrier. Under the irradiation of excitation light, the catalyst on the outer surface of the carrier will generate oxygen-containing free radicals with strong oxidative activity to degrade the target pollutants into intermediate products. The biodegradable intermediate products will be mineralized by the biofilm inside the carrier into H₂O and CO₂, and the non-biodegradable intermediate products will continue to be photocatalytically oxidized until the pollutants are completely mineralized. The system can significantly improve the degradation and mineralization efficiency of pollutants and avoid the problems of excessive oxidation and insufficient degradation caused by improper control of advanced oxidation. The ICPB system needs to add a light source externally and prepare a photocatalyst, which is energy-consuming, costly, and complex. Moreover, the photocatalytic activation of the photocatalyst to initiate electron-hole separation is the key to photocatalytic oxidation. The actual organic industrial tailwater still has high chroma, which will block light and light intensity, so this process is not suitable for treating actual industrial wastewater with high chroma, large turbidity and the like. Gao Qiang et al. proposed in the article “Study on the Coking Wastewater Photocatalytic Degradation” (Sci-Tech Information Development & Economy, 2008, 18 (29): 108-110.) that, when TiO₂ is used as a catalyst to treat the incoming and outgoing water of the biochemical treatment station of a coking plant by ultraviolet irradiation, the degradation effects for COD and NH₃—N are not significant.

ICPB needs to run under illumination, which involves engineering technical issues such as light energy collection or light source installation. Especially when light energy is used for industrial tailwater with high turbidity and high chroma, the photocatalytic efficiency is low due to the hindered light transmission. Therefore, in the treatment of actual industrial tailwater, ICPB exhibits low efficiency and unstable operation, and the ICPB system may even collapse due to biotoxication.

Although the staged combination of ozone oxidation and biodegradation can enhance the degradation of pollutants, this process requires two reactors, a large floor space, increased construction and operating costs, and added operation complexity, and the condition parameters need to be adjusted separately for each unit. In addition, it is difficult to control the ozone oxidation process during operation, and either too-long or too-short ozone oxidation time is not suitable for the operation of the staged combination system and the mineralization of pollutants. Too-short ozone oxidation may lead to incomplete degradation; and too-long ozone oxidation will lead to accumulation of intermediate products and low COD removal rate, is difficult to achieve mineralization and up-to-standard discharge of an effluent and may also result in increased energy consumption and cost.

### SUMMARY OF THE INVENTION

In order to solve the above technical problems, the present disclosure provides an organic industrial tailwater treatment method based on SCOB, where ozonation and biodegradation are conducted in one reactor to realize the integration of ozonation with biodegradation; and easily-degradable organic substances produced from the ozonation can be quickly utilized by microorganisms in internal pores of a composite carrier. The present disclosure improves the degradation and mineralization efficiency of pollutants, effectively reduces the toxicity of an effluent, the floor space, and the construction and operation costs, simplifies the operation process, and requires no external light source and catalyst preparation, which avoids the secondary pollution of a catalyst in the use of ICPB and the effect of wastewater turbidity and chroma. Therefore, the treatment method of the present disclosure is effective, economical and environmentally friendly.

The present disclosure adopts the following technical solutions.

The present invention provides an organic industrial tailwater treatment method based on SCOB, including: placing a sponge carrier that is internally attached and grown with a biofilm in a recycle reactor; using an air pump to introduce air into an ozone generator to generate ozone; and introducing the ozone into the recycle reactor; where, during the process, the ozone output of the recycle reactor is adjusted through a flow meter and an ozone generator adjustment knob; the sponge carrier is uniformly fluidized under the action of the ozone; and microorganisms loaded on the sponge carrier cooperate with the ozone to degrade pollutants.

As a more preferable technical solution of the present disclosure, the sponge carrier may be a polyurethane sponge, and the polyurethane sponge may have a porous honeycomb structure, with a pore size of 0.1 mm to 0.3 mm and a porosity of about 85% to 90%.

As a more preferable technical solution of the present disclosure, the polyurethane sponge may be a cube with a side length of 2 mm to 3 mm, and the polyurethane sponge may have a wet density of about (0.89-0.90)/cm³.

As a more preferable technical solution of the present disclosure, the sponge carrier that is attached and grown with a biofilm is prepared by the following method: taking sludge from an aerobic tank of a sewage treatment plant, and subjecting the sludge to static settling for 1 h to 3 h for separating; removing a resulting supernatant, and conducting aeration for 1 d to 3 d to activate the sludge; soaking a sponge carrier in activated sludge, stirring appropriately, and continuously aerating for 1 d to 3 d to allow the pores and framework of the sponge carrier to fully adsorb the activated sludge; transferring the sponge carrier with the activated sludge adsorbed to a complete-mix continuous-flow recycle reactor for further cultivation, and supplementing a specified amount of the to-be-treated industrial wastewater as a nutrient to enable COD:N:P=100:(5-10):(1-5); and cultivating for 7 d to 10 d.

As a more preferable technical solution of the present disclosure, the recycle reactor may be made of polymethyl methacrylate (PMMA), with a height of 180 mm, an outer diameter of 80 mm, an inner diameter of 70 mm; a 60° ramp may be disposed at the bottom of the recycle reactor, and the ramp can provide a shearing force to allow the sponge carrier to be better fluidized in the reactor and avoid accumulation of sponge carriers at the bottom of the reactor; and an aerator may be installed on the recycle reactor to introduce ozone into the reactor, which in turn promotes the continuous fluidization of the sponge carrier in the reactor.

As a more preferable technical solution of the present disclosure, the ozone may be introduced at an amount of 40 mg/(L·h) to 100 mg/(L·h).

Beneficial Effects:

The present disclosure constructs an economical and engineeringly-feasible SCOB system to treat organic industrial tailwater. The relationship involved in the SCOB is as follows: in a reactor, ozone molecules and free radicals such as .OH produced by the decomposition of the ozone molecules oxidize organics with low biodegradability into biodegradable small molecular substances, which can be used as nutrients by the microorganisms in the sponge carrier, enabling both the growth and reproduction of microorganisms and the further degradation and mineralization of pollutants. In this system, the rich pores in the sponge carrier protect the microorganisms and reduce the damage of ozone and free radicals to the microorganisms. Moreover, as the microorganisms and ozone participate in reaction in the same reactor, this near-field environment allows the toxic intermediate products from ozonation of pollutants to be rapidly degraded by microorganisms. The SCOB effectively avoids accumulation of intermediate products, increases the mineralization, and reduces the toxicity of treated wastewater.

The present disclosure has significant advantages in practical applications. The biodegradable intermediate products produced from ozonation can be rapidly metabolized and mineralized by microorganisms, thereby significantly reducing the toxicity and COD of industrial tailwater. At an ozone dosage of 100 mg/(L·h), the SCOB system can degrade the biochemical tailwater of coking wastewater with a COD removal rate of about 75%, which is superior to the ozone degradation alone (with a COD degradation rate of about 60%) and the biodegradation alone (basically no COD removal) under the same conditions. Moreover, it is found from the biotoxicity detection by Vibrio qinghaiensis Q607 that the toxicity of wastewater is significantly reduced after the SCOB degradation is applied, but the acute toxicity increases when the ozone degradation is applied alone, and the toxicity of an effluent does not change significantly when the biodegradation is applied alone. Therefore, the SCOB provides a novel and efficient technical solution and method theory for the up-to-standard discharge, advanced treatment and toxicity reduction of industrial tailwater.

In summary, the SCOB system established in the present disclosure enables the ozonation and biodegradation to be conducted in one reactor, thereby realizing the integration of ozonation with biodegradation. The present disclosure reduces the floor space and the construction and operation costs, simplifies the operation process, and requires no external light source and catalyst preparation, which avoids the secondary pollution of a catalyst in the use of ICPB. Therefore, the treatment method is effective, economical and environmentally friendly.

### BRIEF DESCRIPTION OF THE FIGURES

FIG. 1 is a schematic diagram of the working device according to the present disclosure.

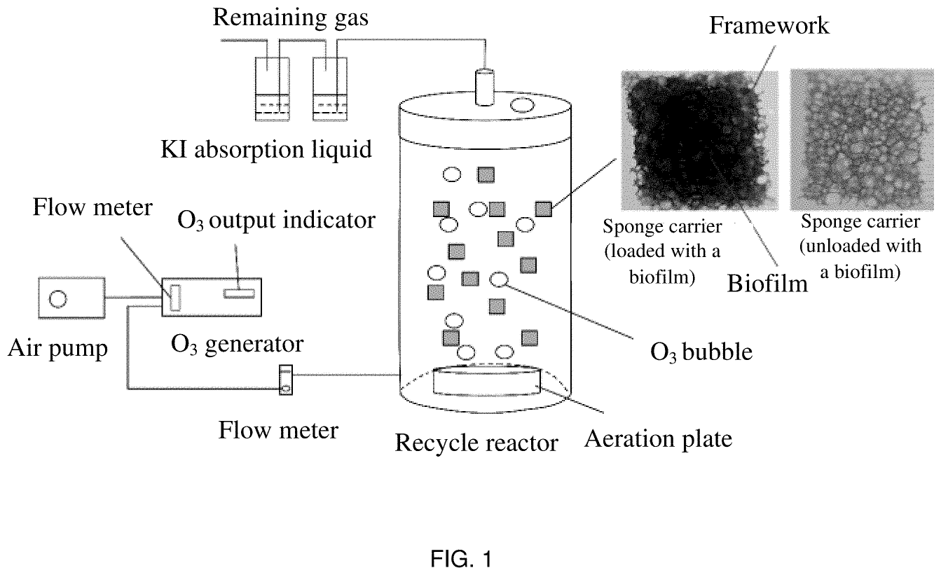

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide an improved SCOB wastewater treatment system.

The present disclosure is further described below with reference to specific Embodiments.

The present disclosure provides an organic industrial tailwater treatment method based on SCOB, including: placing a sponge carrier that is internally attached and grown with a biofilm in a recycle reactor; using an air pump to introduce air into an ozone generator to generate ozone; and introducing the ozone into the recycle reactor; where, during the process, the ozone output of the recycle reactor is adjusted through a flow meter and an ozone generator adjustment knob, the sponge carrier is uniformly fluidized under the action of the ozone, and microorganisms loaded on the sponge carrier cooperate with the ozone to degrade pollutants.

The recycle reactor may be made of PMMA, with a height of 180 mm, an outer diameter of 80 mm, an inner diameter of 70 mm; a 60° ramp may be disposed at the bottom of the recycle reactor, and the ramp can provide a shearing force to allow the sponge carrier to be better fluidized in the reactor and avoid accumulation of sponge carriers at the bottom of the reactor; and an aerator may be installed on the recycle reactor to introduce ozone into the reactor, which in turn promotes the continuous fluidization of the sponge carrier in the reactor.

The device for the SCOB may include a mixed internal recycle reactor, an ozone generator, and a porous sponge carrier loaded with a biofilm. Air is first introduced into the ozone generator via the air pump to produce ozone, and by adjusting the flow meter and the output of the ozone generator, a specified amount of ozone is introduced into the internal recycle reactor. The sponge carrier is uniformly fluidized under the action of ozone, and the microorganisms loaded on the sponge framework cooperate with the ozone to degrade pollutants. The ozone and free radicals such as .OH generated by decomposition of the ozone first oxidize organics with low biodegradability into biodegradable small molecular substances, which are rapidly further degraded and mineralized as nutrients by microorganisms in the sponge carrier. While degrading pollutants, the system also provides nutrients for the continued growth of microorganisms, so that the system can continue to operate, thereby constructing an SCOB system.

Embodiment 1: Cultivation of a Biofilm with a Porous Sponge as a Carrier

Sludge was taken from an aerobic tank of a sewage treatment plant, and subjected to static settling for 1 h to 3 h for separating; a resulting supernatant was removed, and aeration was conducted for 1 d to 3 d to activate the sludge; a sponge carrier was soaked in activated sludge, and a resulting mixture was stirred appropriately and continuously aerated for 1 d to 3 d to allow the pores and framework of the sponge carrier to fully adsorb the activated sludge; the sponge carrier with the activated sludge adsorbed was transferred to a complete-mix continuous-flow recycle reactor for further cultivation, and a specified amount of the to-be-treated industrial wastewater was supplemented as a nutrient to enable COD:N:P=100:(5-10):(1-5); and cultivation was conducted for 7 d to 10 d.

The sponge carrier may be a polyurethane sponge, and the polyurethane sponge may have a porous honeycomb structure, with a pore size of 0.1 mm to 0.3 mm and a porosity of about 85% to 90%. The polyurethane sponge may be a cube with a side length of 2 mm to 3 mm, and the polyurethane sponge may have a wet density of about 0.89-0.90g/mL.

Embodiments 2 to 4

The effluent quality of coking wastewater from a coking plant is shown in Table 1:

TABLE 1

| Item | Range | Unit |
|---|---|---|
| pH | 7.5-8.0 | |
| COD | 500-600 | mg/L |
| BOD₅ | 40-80 | mg/L |
| TN | 70.8 | mg/L |
| Total phenol | 56.7 | mg/L |
| Cl⁻ | 790 | mg/L |
| Chroma | 600 | times |
| SS | 74 | mg/L |

COD represents chemical oxygen demand (COD);
BOD₅ represents five-day biochemical oxygen demand (BOD₅);
TN represents total nitrogen (TN) in water; and
SS represents suspended solids (SS).

500 mL of the coking wastewater effluent in Table 1 was taken and added to the SCOB reactor, and 2,000 sponge carriers loaded with a biofilm in Embodiment 1 were added at the same time. The air pump and the ozone generator were turned on, and the ozone dosage was adjusted and controlled to 40 mg/(L·h), 80 mg/(L·h), and 100 mg/(L·h) separately by adjusting the output of the ozone generator and the flow meter. After reaction started, every 8 h was counted as a cycle, and 70% of the coking wastewater was replaced at the end of each cycle. The system began to enter a stable period from the fourth cycle, and the microorganisms adapted to the environment, and the system reached a stable state. The results are shown in Table 2.

TABLE 2

| | | | Increasing | |
|---|---|---|---|---|
| | | | rate of the | |
| | | | degradation | Vibrio |
| | | | rate constant | qinghaiensis |
| | | | of total | Q67 |
| | | COD | phenol | Inhibition |
| | Ozone | removal rate | (SCOB | rate |
| | dosage | SCOB | relative to | (untreated, |
| Embodiment | (mg/(L · h)) | (O₃) | O₃) | 42%) |
| No. 2 | 40 | 38% (25%) | 68.3% | 38% |
| No. 3 | 80 | 50% (40%) | 65% | 30% |
| No. 4 | 100 | 75% (60%) | 60% | 27% |

After the SCOB treatment was conducted with an ozone dosage of 100 mg/(L·h), the COD removal rate of coking wastewater was about 75%, an increase of about 15% relative to the COD removal rate of about 60% achieved by the O₃ degradation alone; the total phenol degradation was close to 100%, but the degradation rate constant of total phenol achieved by SCOB increased by about 60% compared to the O₃ degradation alone; and the inhibition rate of coking wastewater on Vibrio qinghaiensis Q67 was reduced from 42% to 27%, a decrease of about 15%. This indicated that the SCOB had achieved the successful treatment of coking wastewater.

Embodiments 5 to 7

The tailwater quality of a pharmaceutical factory is shown in Table 3 below:

TABLE 3

| Item | Range | Unit |
|---|---|---|
| COD | 180-200 | mg/L |
| BOD₅ | 61 | mg/L |
| Chroma | 60 | times |
| Turbidity | 19.9 | NTU |
| SS | 0.079 | mg/L |
| NH4⁺—N | 39.21 | mg/L |
| TDS | 11.18 | ppt |
| Salinity | 13.13 | psu |
| Conductivity | 22.77 | ms/cm |
| Resistivity | 43.83 | ohm-cm |

*COD represents chemical oxygen demand (COD);
*BOD₅ represents five-day biochemical oxygen demand (BOD₅);
*SS represents suspended solids (SS); and
*TDS represents the total dissolved solids (TDS).

500 mL of the pharmaceutical factory tailwater in Table 3 was taken and added to the reactor of the present disclosure, and 2,000 sponge carriers loaded with a biofilm were added at the same time. The air pump and the ozone generator were turned on, and the ozone dosage was adjusted and controlled to 10 mg/(L·h), 20 mg/(L·h), and 40 mg/(L·h) by adjusting the output of the ozone generator and the flow meter. After reaction started, every 8 h was counted as a cycle, and 70% of the pharmaceutical factory tailwater was replaced at the end of each cycle. The system began to enter a stable period from the fourth cycle, and the microorganisms adapted to the environment, and the system reached a stable state. The results are shown in Table 4.

TABLE 4

| | | | Vibrio qinghaiensis |
|---|---|---|---|
| | Ozone | COD | Q67 |
| | dosage | removal rate | Inhibition rate |
| Embodiment | (mg/(L · h)) | (O₃) | (untreated, 70%) |
| No. 5 | 10 | 34% (20%) | 60% |
| No. 6 | 20 | 62% (44%) | 45% |
| No. 7 | 40 | 80% (50%) | 20% |

It can be seen from the above that the SCOB treatment with an ozone dosage of 40 mg/(L·h) achieved a COD removal rate of about 80%, which was superior to that of the ozone degradation alone (about 50%). The inhibitory rate of the pharmaceutical wastewater on Vibrio qinghaiensis Q67 was reduced from 70% to 20%, a decrease of about 50%. The toxicity of the effluent of the pharmaceutical factory wastewater treated by the method provided by the present disclosure was lower than that of the effluent obtained from the ozone degradation alone, indicating that the method of the present disclosure was better than the ozone degradation alone at the same dosage, and achieved the successful treatment of the pharmaceutical tailwater.

COD, total phenol, and effluent toxicity all showed that the SCOB process was better than the O₃ degradation alone, and the degradation rate increased with the increase of ozone dosage. For industrial tailwater with high COD (500 to 600), an ozone dosage of 100 mg/(L·h) led to a preferable degradation effect; and for industrial tailwater with low COD (180 to 200), an ozone dosage of 40 mg/(L·h) led to a preferable degradation effect. Therefore, the recommended ozone dosage for SCOB degradation of organic industrial tailwater was 40 mg/(L·h) to 100 mg/(L·h).

In summary, the SCOB system established in the present disclosure realizes the integration of ozonation with biodegradation, which reduces the floor space and the construction and operation costs. The present disclosure requires no light source, is not affected by the turbidity and chroma of wastewater and does not involve the limitation of catalyst loading stability. Therefore, the method of the present disclosure has significant application advantages in practical applications and is an economical and engineeringly-feasible SCOB system.

The following claims are thus to be understood to include what is specifically illustrated and described above, what is conceptually equivalent, what can be obviously substituted and also what incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. An organic industrial tailwater treatment method based on simultaneous combination of ozonation and biodegradation (SCOB), comprising the steps of:
placing a sponge carrier that is internally attached and grown with a biofilm in a recycle reactor;
using an air pump to introduce air into an ozone generator to generate ozone; and
introducing the ozone into the recycle reactor;
wherein, during the process, the ozone output of the recycle reactor is adjusted through a flow meter and an ozone generator adjustment knob, the sponge carrier is uniformly fluidized under the action of the ozone, and microorganisms loaded on the sponge carrier cooperate with the ozone to degrade pollutants.

2. The organic industrial tailwater treatment method based on SCOB according to claim 1, wherein, the sponge carrier is a polyurethane sponge, and the polyurethane sponge has a porous honeycomb structure, with a pore size of 0.1 mm to 0.3 mm and a porosity of about 85% to 90%.

3. The organic industrial tailwater treatment method based on SCOB according to claim 1, wherein, the polyurethane sponge is a cube with a side length of 2 mm to 3 mm, and the polyurethane sponge has a wet density of about (0.89-0.90)/cm³.

4. The organic industrial tailwater treatment method based on SCOB according to claim 1, wherein, the sponge carrier that is attached and grown with a biofilm is prepared by the following method: taking sludge from an aerobic tank of a sewage treatment plant, and subjecting the sludge to static settling for 1 h to 3 h for separating; removing a resulting supernatant, and conducting aeration for 1 d to 3 d to activate the sludge; soaking a sponge carrier in activated sludge, stirring appropriately, and continuously aerating for 1 d to 3 d to allow the pores and framework of the sponge carrier to fully adsorb the activated sludge; transferring the sponge carrier with the activated sludge adsorbed to a complete-mix continuous-flow recycle reactor for further cultivation, and supplementing a specified amount of the to-be-treated industrial wastewater as a nutrient to enable COD:N:P=100:(5-10):(1-5); and cultivating for 7 d to 10 d.

5. The organic industrial tailwater treatment method based on SCOB according to claim 1, wherein, the recycle reactor is made of polymethyl methacrylate (PMMA), with a height of about 180 mm, an outer diameter of about 80 mm, an inner diameter of about 70 mm; a ramp of about 60° is disposed at the bottom of the recycle reactor, and the ramp can provide a shearing force to allow the sponge carrier to be better fluidized in the reactor and avoid accumulation of sponge carriers at the bottom of the reactor; and an aerator is installed on the recycle reactor to introduce ozone into the reactor, which in turn promotes the continuous fluidization of the sponge carrier in the reactor.

6. The organic industrial tailwater treatment method based on SCOB according to claim 1, wherein, wherein, the ozone is introduced at an amount of about 40 mg/(L·h) to about 100 mg/(L·h).
